(19) United States
(12) Patent Application Publication
(10) Pub. No.: US 2018/0304784 A1
(43) Pub. Date: Oct. 25, 2018

(54) Removable Waterproof Car Seat Cover

(71) Applicant: Devon C Ricks, Capitola, CA (US)

(72) Inventor: Devon C Ricks, Capitola, CA (US)

(21) Appl. No.: 15/495,381

(22) Filed: Apr. 24, 2017

(51) Int. Cl. B60N 2/60

(52) U.S. Cl. CPC B60N 2/60; B60N 2/6063

(57) ABSTRACT

A temporary seat cover has a first portion configured as a pocket portion, having an opening on a lower side, sized to enclose a headrest of a vehicle bucket seat, and a second portion of a width and length sufficient to cover the bucket seat below the headrest, the second portion constructed in two layers, a first, upper layer, comprising a wicking, water-absorbent material, and a second, lower layer, beneath the first layer, of a waterproof material. A user acquires the temporary seat cover storage, places the pocket portion over the headrest of the bucket seat, and forms the second portion over the backrest and seat of the bucket seat, such that, as the user sits on the seat, water is absorbed by the wicking, water-absorbent material of the first layer, and the second layer, of a waterproof material, prevents water from affecting the permanent covering of the bucket seat.

### BACKGROUND OF THE INVENTION

### 1. Field of the Invention

The present invention is in the field of seat covers, particularly for vehicle seats.

### 2. Description of Related Art

Seats in a vehicle are generally a part of the vehicle with which a person makes the most contact. Car seats may therefore be subject to being soiled or damage caused by the person sitting in the seat. Practical examples may include a person driving home after a strenuous workout, wet and muddy clothing caused by rainy weather, divers or surfers with no way to change before getting in the car, people after engaging in hot yoga or Bikram yoga, or spin classes, or just dirty clothes from outdoor activities. Unfortunately, car seats are generally not easily cleaned. The seats may not have removable covers, and, especially for cloth seats, may require additional equipment that many people may not readily have on hand.

Seat covers presently in the art may be considered to be uncomfortable, or not effective enough at preventing soiling or particularly damage by water or perspiration. Additionally, present seat covers may not have a user-friendly storage solution, or may not have high portability to allow users to easily transport a seat cover, and to have a way to protect their car seat on hand when the situation arises. Therefore, what is clearly needed is a seat cover that is both comfortable, and effective enough for the most demanding situations, while at the same time providing a user-friendly storage solution and portability.

### BRIEF SUMMARY OF THE INVENTION

In one embodiment of the present invention, a temporary seat cover for a bucket seat is provided, comprising a first portion configured as a pocket portion, having an opening on a lower side, sized to enclose a headrest of a vehicle bucket seat, and a second portion, extending downward from the first portion, of a width and length sufficient to cover the bucket seat below the headrest, the second portion constructed in two layers, a first, upper layer, comprising a wicking, water-absorbent material, and a second, lower layer, beneath the first layer, of a waterproof material. A user, prior to entering a vehicle, acquires the temporary seat cover from a storage location, places the pocket portion over the headrest of the bucket seat, and forms the second portion over the backrest and seat of the bucket seat, such that, as the user enters the vehicle and sits on the seat, water from the user's attire is absorbed by the wicking, water-absorbent material of the first, upper layer, and the second layer, of a waterproof material, prevents water from affecting the permanent covering of the bucket seat.

In one embodiment, the second portion, extending downward from the first portion, is formed in an upper section just below the first portion, to enclose an upper part of the backrest. Also in one embodiment, the seat cover further comprises one or more elastic cinch bands joined along edges of the second portion, such that the second portion is conformed to the shape of the bucket seat. And in one embodiment the seat cover further comprises a closure apparatus with compatible parts on opposite sides of the opening on the lower side of the first portion, such that the first portion serves as a storage pocket for the second portion, the second portion folded upward into the first portion, and the closure apparatus closed.

In one embodiment of the invention the closure apparatus comprises a loop and a button on opposite sides of the opening. Also in one embodiment, the first portion comprises the same two layers as the second portion. And in one embodiment, the seat cover has opposite side portions joined to the second portion, such that the seat cover takes the overall outer shape of the bucket seat.

### BRIEF DESCRIPTION OF THE SEVERAL VIEWS OF THE DRAWINGS

FIG. 1 is a perspective view of a seat cover tucked into the headrest cover portion of the seat cover according to one embodiment of the present invention.

FIG. 2A is a perspective view of a seat cover installed on an exemplary car seat according to one embodiment of the present invention.

FIG. 2B is a front view of the seat cover of FIG. 2A.

FIG. 2C is a side view of the seat cover of FIG. 2A.

FIG. 2D is a back view of the seat cover of FIG. 2A.

FIG. 3 is a sectional view of an exemplary car seat with the seat cover of FIG. 2A.

FIG. 4A is a perspective view of a fitted car seat installed on an exemplary car seat according to one embodiment of the present invention.

FIG. 4B is a left-side view of the fitted car of FIG. 4A.

FIG. 4C is a right-side view of the fitted car seat of FIG. 4A.

### DETAILED DESCRIPTION OF THE INVENTION

What is generally provided in embodiments of the present invention is a car seat cover which is removable, and provides protection to car seats against moisture and dirt.

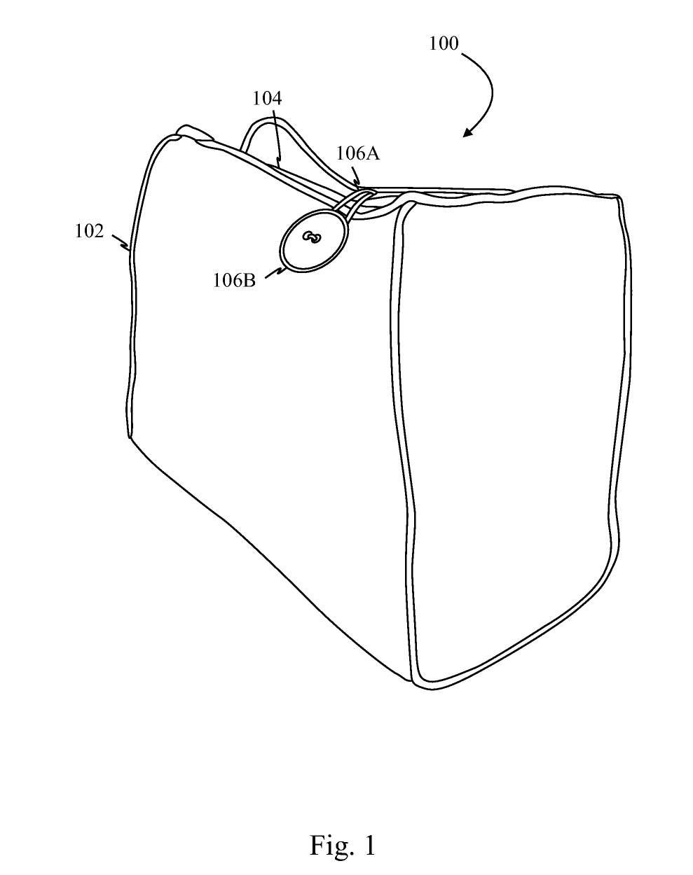

FIG. 1 is a perspective view of a car seat cover 100 in a storage configuration. In this configuration, headrest cover 102 of car seat cover 100 may act as a storage container for body cover 104 (not fully shown in FIG. 1, but shown in further detail below). The car seat cover 100 may have a closure system comprising, for example, a loop 106A and a button 106B (henceforth referred to collectively as button-loop closure 106), to securely hold the body cover 104 inside the headrest cover 102. In place of the button-loop closure 106, other embodiments may have other types of closure mechanisms, for example loop and hook fastener, hooks, cinch cords, or the like. One advantage provided by the dual-purpose of the headrest cover 102 is that a user may be able to easily store and transport one or more seat covers, and be able to use the seat covers only when needed. This may be useful in situations where a need for a seat cover is unplanned, such as unexpected rainy weather.

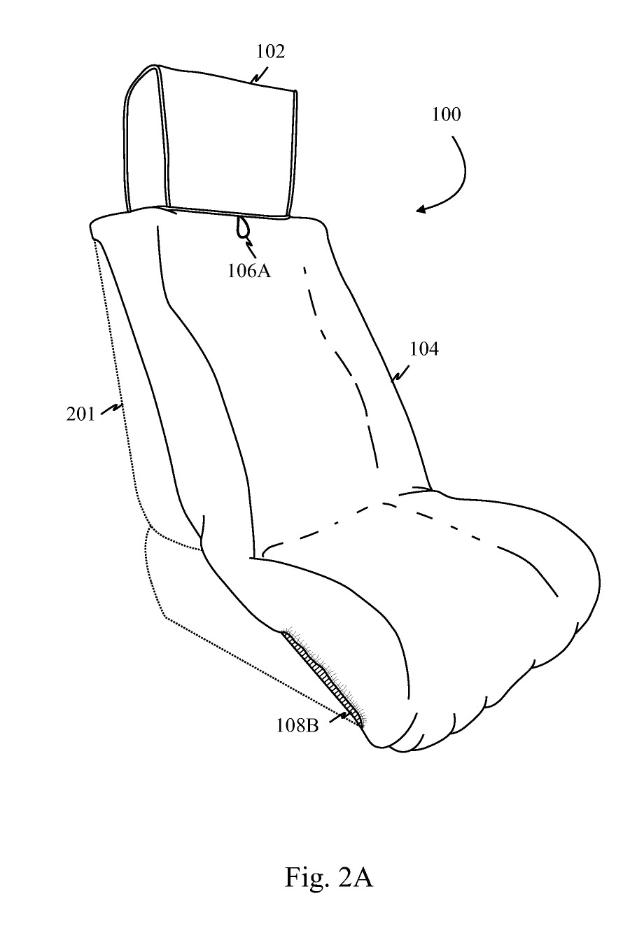

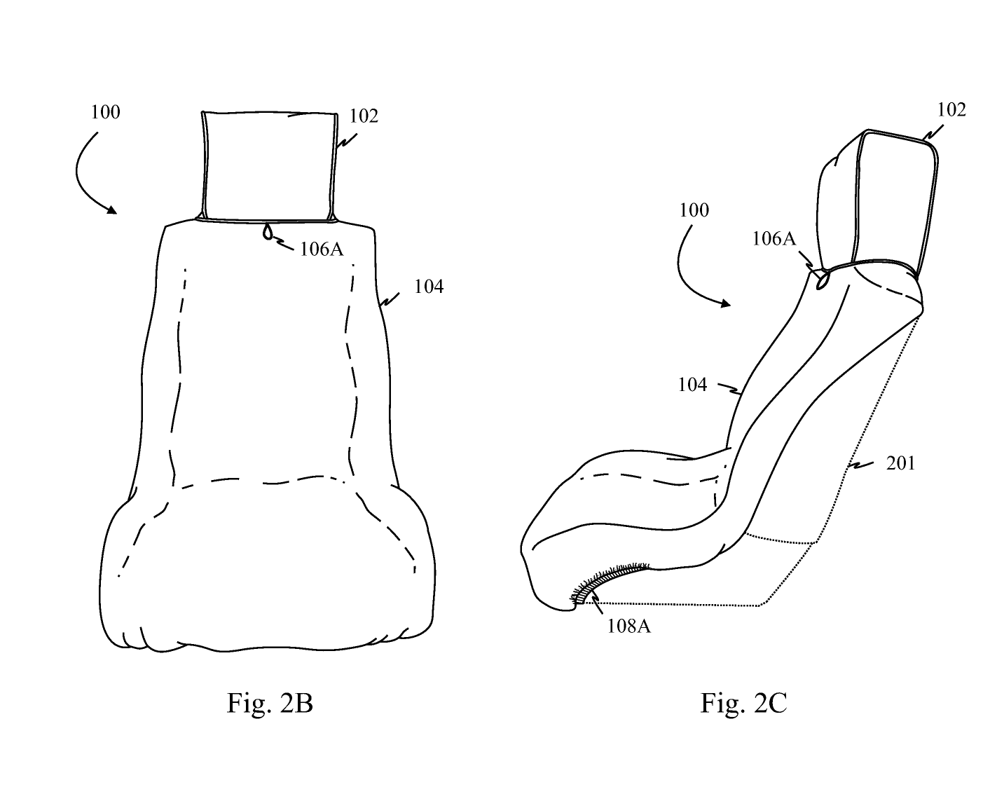

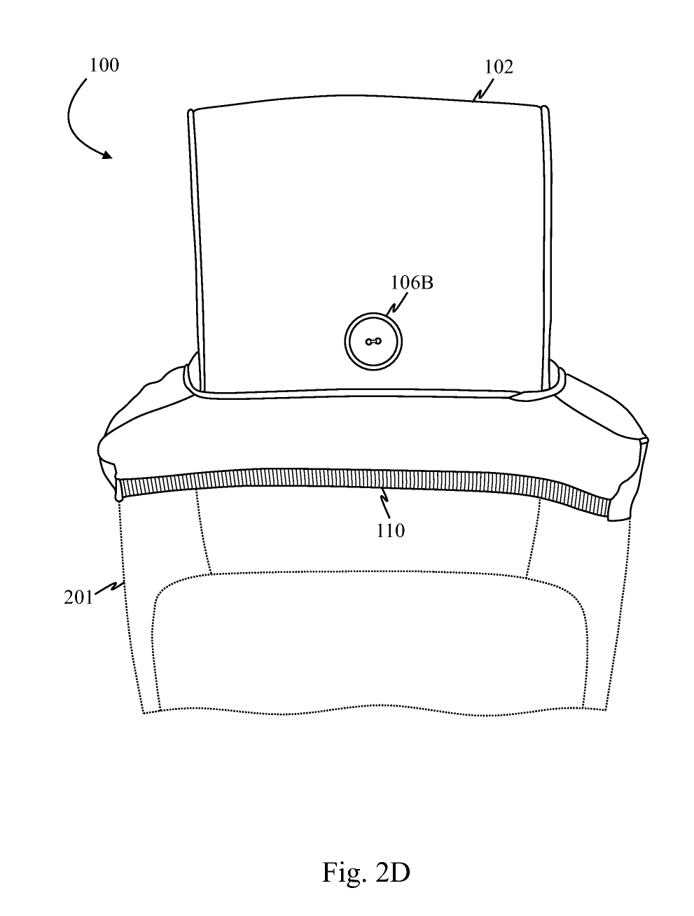

Series FIGS. 2A through 2D are various views of a car seat cover 100 installed on an exemplary bucket seat 201 according to one embodiment of the present invention. FIG. 2A is a perspective view of the car seat cover installed on the exemplary bucket seat. As seen in FIG. 2A, the car seat cover has two main components: the headrest cover 102, and body cover 104. The headrest cover 102 may cover a headrest of the bucket seat 201 while acting as a holding point, and provides leverage for the rest the car seat cover. The body cover drapes down and covers the backrest and seat cushion areas of the bucket seat 201. As seen in FIGS. 2A and 2C, this embodiment uses elastic bands 108A and 108B sewn or otherwise joined into body cover 104 on both sides of the bottom of the seat of bucket seat 201 to enable the body cover 104 to effectively engage the bottom edges of the bucket seat, so that the lower portion of the body cover may remain in place while in use. On the back side of body cover 104, as in FIG. 2D, there is, in this embodiment, another elastic band 110 to hold the backrest portion of body cover 104 in place while in use. In addition to holding the car seat cover 100 in place, the elastic bands 108A, 108B, and 110 also make it a simple task to put on and remove the car seat cover 100. In other embodiments, the elastic bands 108A, 108B, and 110 may be other types of materials or methods to secure body cover 104 to the bucket seat 201 such as, but not limited to, hooks, bungee cords, cinches, buttons, or hook and loop fasteners. The body cover 104 utilizes a multi-layer design of different materials as detailed below.

The utilization of elastic chinch stripe along various edges allows for provision of waterproof seat covers in embodiments of the invention, that may be useful and cover bucket seats of different sizes and shapes.

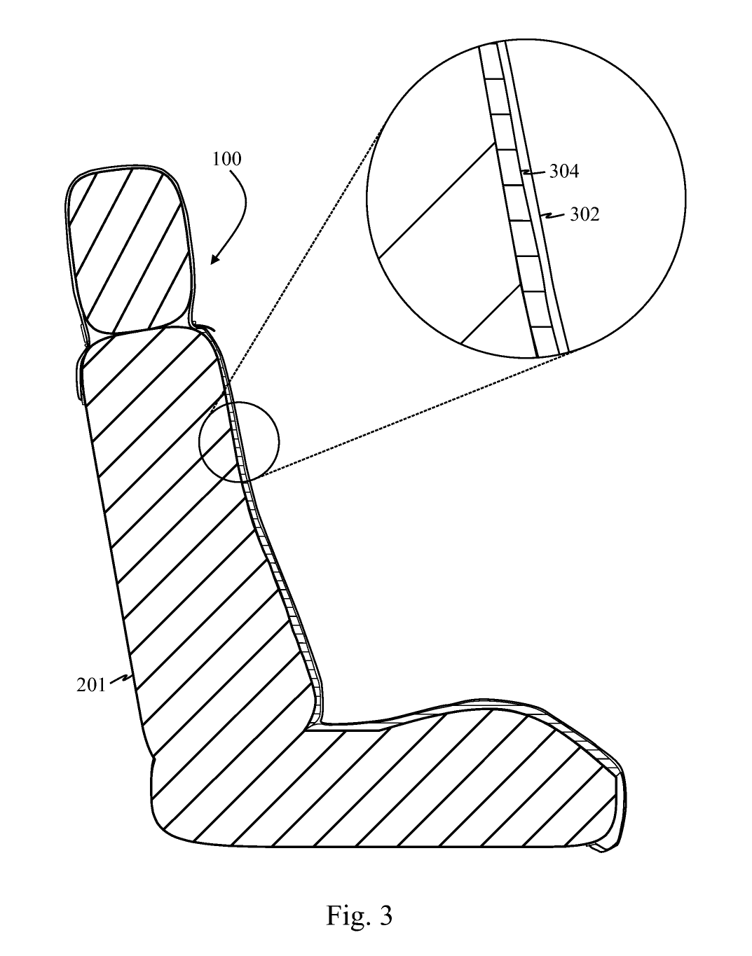

FIG. 3 is a cross-section view with magnified portion, of car seat cover 100 installed on exemplary bucket seat 201 according to one embodiment of the present invention. As shown in FIG. 3, the car seat cover 100 in this embodiment utilizes two layers: a top layer 302 with absorbent, quick-drying and moisture wicking properties, and a bottom layer 304 that is waterproof. The top layer 302 may be suitable for situations involving a lower amount of moisture, such as sweat after a workout session, damp clothing, left-over wetness after swimming, people after engaging in hot yoga or Bikram yoga, or spin classes, or the like. The moisture wicking properties may, additionally, enable the car seat cover 100 to draw moisture from clothes or the body of a person sitting on the bucket seat 201 to allow them to dry faster. The bottom layer 304 provides a deeper protection from high levels of moisture, such as sitting on the bucket seat 201 after scuba diving without removing one's wetsuit, rainy weather, or the like. The top layer 302 may be any type of quick-dry and wicking fabrics, and, similarly, the bottom layer 304 may be any waterproof fabric.

FIG. 3 shows this embodiment only uses a dual-layer of materials in the portions of the car seat cover 200 that covers the backrest and seat cushion of bucket seat 201, but not the headrest pocket. This is so the seat cover, packed away in the headrest covering, will have a chance to dry, as the headrest pocket, fashioned from the wicking layer, in some embodiments polyester, will allow passage of moisture. But other embodiments may utilize the dual-layer of materials in more areas or fewer areas, depending on the needs and requirements of a user, without deviating from the inventive concept of the present invention.

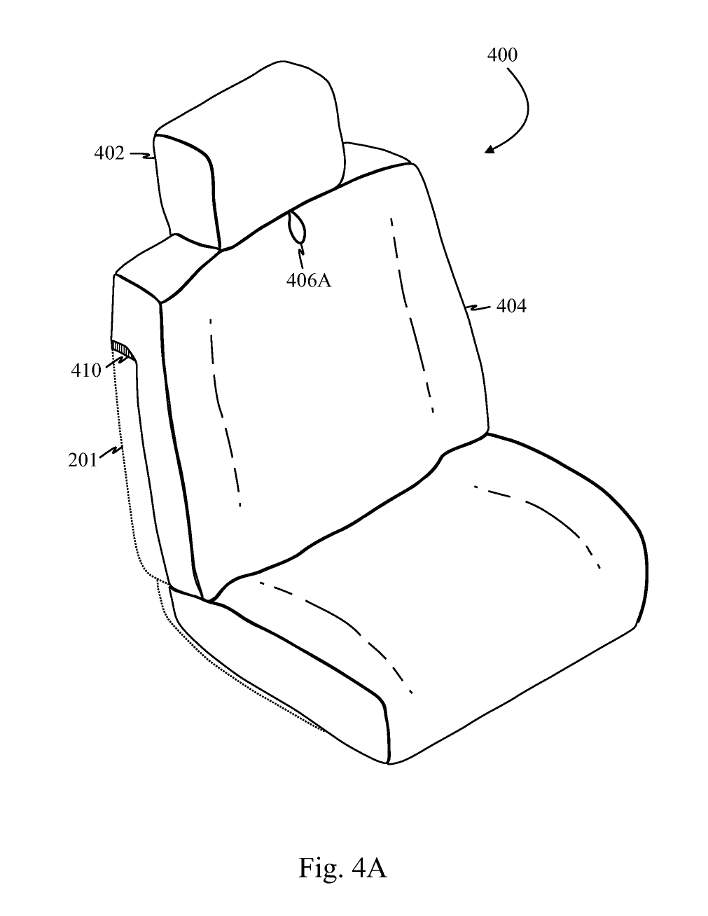

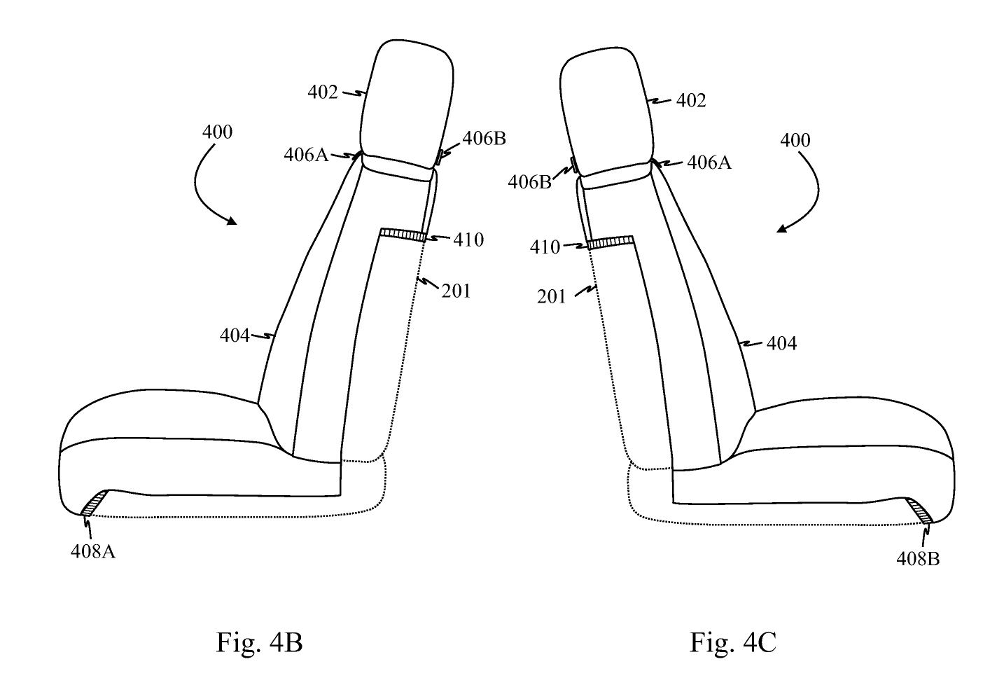

FIG. 4A is a perspective view of a fitted car seat cover 400 according to another embodiment of the present invention, and FIGS. 4B and 4C are side views of this embodiment. The fitted car seat cover 400 may have many features and functions that may be found in a non-fitted car seat cover 100: a headrest cover 402 which may double as a storage pouch, a body cover 404, a loop 406A and a button 406B to make a button-loop closure, bottom elastic bands 408A 408B, and back elastic band 410. The fitted car seat cover 400 may also use a dual-layer design in certain portions, similar to the non-fitted car seat cover 100. Where the fitted car seat cover 400 may differ from the non-fitted car seat cover 100 is in the closeness of the fit. Whereas on the non-fitted car seat cover 100, the body cover 104 may be a single body that covers the bucket seat 201 and may fit relatively loosely, the fitted car seat cover 400 may be constructed from multiple panels and may be tailored to fit neatly and with more tautness for any designated bucket seat. While the elastic bands 408A 408B and 410 may enable fitted car seat cover 400 to be removed, it may be somewhat more difficult to remove than the non-fitted car seat cover 100, and may be more suited for a semi-permanent installation where the fitted car seat cover 400 is removed only occasionally for maintenance and cleaning.

Although the above examples use only bucket seats, there may be embodiments in which the car seat cover is adapted to fit on a bench seat of a car. For example, one embodiment may have a plurality of head rest covers that may fit over the head rests of the bench seat, and some means to secure the bottom portion of the body cover of the bench seat cover to the bottom lip and sides of the bench seat. Another embodiment may not have a headrest cover, and have other means to secure the upper portion of the seat cover to the seat.

It will be apparent to one with skill in the art, that the embodiments described above are specific examples of a single broader invention which may have greater scope than any of the singular descriptions taught. There may be many alterations made in the descriptions without departing from the spirit and scope of the present invention.

1. A temporary seat cover for a bucket seat, comprising:
a first portion configured as a pocket portion, having an opening on a lower side, sized to enclose a headrest of a vehicle bucket seat; and
a second portion, extending downward from the first portion, of a width and length sufficient to cover the bucket seat below the headrest, the second portion constructed in two layers, a first, upper layer, comprising a wicking, water-absorbent material, and a second, lower layer, beneath the first layer, of a waterproof material;
wherein a user, prior to entering a vehicle, acquires the temporary seat cover from a storage location, places the pocket portion over the headrest of the bucket seat, and forms the second portion over the backrest and seat of the bucket seat, such that, as the user enters the vehicle and sits on the seat, water from the user's attire is absorbed by the wicking, water-absorbent material of the first, upper layer, and the second layer, of a waterproof material, prevents water from affecting the permanent covering of the bucket seat.

2. The temporary seat cover of claim 1, wherein the second portion, extending downward from the first portion, is formed in an upper section just below the first portion, to enclose an upper part of the backrest.

3. The temporary seat cover of claim 2 further comprising one or more elastic cinch bands joined along edges of the second portion, such that the second portion is conformed to the shape of the bucket seat.

4. The temporary seat cover of claim 1, further comprising a closure apparatus with compatible parts on opposite sides of the opening on the lower side of the first portion, such that the first portion serves as a storage pocket for the second portion, the second portion folded upward into the first portion, and the closure apparatus closed.

5. The temporary seat cover of claim 4 wherein the closure apparatus comprises a loop and a button on opposite sides of the opening.

6. The temporary seat cover of claim 1 wherein the first portion comprises the same two layers as the second portion.

7. The temporary seat cover of claim 1 comprising opposite side portions joined to the second portion, such that the seat cover takes the overall outer shape of the bucket seat.

8. The temporary seat cover of claim 4 wherein the closure apparatus comprises one of hook and loop fasteners, or integrated strap cinching systems.
